(19) United States
(12) Patent Application Publication
(10) Pub. No.: US 2026/0079734 A1
(43) Pub. Date: Mar. 19, 2026

(54) SYSTEMS AND METHODS FOR INTEGRATION OF AI-BASED USER INTERFACE ELEMENTS

(71) Applicant: Salesforce, Inc., San Francisco, CA (US)

(72) Inventors: Tommy DALE, San Diego, CA (US); Alan WEIBEL, Reno, NV (US); Yon Aran RHEE, Dunedin (NZ); Clifford SEAL, Atlanta, GA (US); Divya HARIHARAN, Seattle, WA (US); Cong NIU, San Mateo, CA (US); Austin Richard GUEVARA, Indianapolis, IN (US)

(73) Assignee: Salesforce, Inc., San Francisco, CA (US)

(21) Appl. No.: 19/022,533

(22) Filed: Jan. 15, 2025

Related U.S. Application Data
(60) Provisional application No. 63/695,182, filed on Sep. 16, 2024.

(51) Int. Cl. G06F 9/451

(52) U.S. Cl. CPC G06F 9/453

(57) ABSTRACT

Disclosed herein are system, method, and computer program product embodiments for an improved integrated AI assistant. The integrated AI assistant performs a plurality of tasks within a host system including providing predictive action suggestions, generating clickable results, updating objects, searching fields, updating fields, determining the AI-generated content within a field, providing chat histories, and providing citations.

### CROSS-REFERENCE TO RELATED APPLICATIONS

The present application claims benefit to U.S. Provisional Ser. No. 63/695,182, filed Sep. 16, 2024, which is hereby incorporated by reference in its entirety.

### BACKGROUND

The proliferation of artificial intelligence (AI) has led to numerous advances in the ability of systems to analyze data and generate predictions. With these advancements, businesses have become increasingly interested in utilizing AI within their workflows. AI is starting to become integrated into a wide variety of fields, such as research, agent response, healthcare, translation, content creation, and a wide array of business applications, through chatbots. Chatbots are computer programs that simulate human conversation through AI, natural language processing (NLP), machine learning (ML), and automated rules. Chatbots have recently become even more robust with the proliferation of Large Language Models (LLMs) that allow the chatbot to orchestrate a complex workflow of processes and data to deliver a result that would have previously required a user to access multiple actions.

One or more aspects of the present disclosure relate to the field of AI integration, and more specifically to a modified and improved integrated chatbot service that provides a user-friendly and efficient workflow for users.

### BRIEF DESCRIPTION OF THE DRAWINGS

The accompanying drawings are incorporated herein and form a part of the specification.

FIG. 1 illustrates an exemplary AI-integrated environment, according to aspects of the present disclosure.

FIG. 2 illustrates a block diagram of an exemplary AI service in an AI-integrated environment, according to aspects of the present disclosure.

FIG. 3A illustrates a flowchart diagram of an exemplary method for generating action suggestions in an AI-integrated environment, according to aspects of the present disclosure.

FIGS. 3B-3C depict an exemplary interface for providing action suggestions via a chat interface, according to aspects of the present disclosure.

FIG. 4A illustrates a flowchart diagram of an exemplary method for generating clickable results in an AI-integrated environment, according to aspects of the present disclosure.

FIGS. 4B-4C depict an exemplary interface for providing clickable results via a chat interface, according to aspects of the present disclosure.

FIG. 5A illustrates a flowchart diagram of an exemplary method for updating objects in an AI-integrated environment, according to aspects of the present disclosure.

FIG. 5B depicts an exemplary interface for updating objects via a chat interface, according to aspects of the present disclosure.

FIG. 6A illustrates a flowchart diagram of an exemplary method for searching for records in an AI-integrated environment, according to aspects of the present disclosure.

FIGS. 6B-6D depict an exemplary interface for record searching via a chat interface, according to aspects of the present disclosure.

FIG. 7A illustrates a flowchart diagram of an exemplary method for content generation and modification in an AI-integrated environment, according to aspects of the present disclosure.

FIG. 7B depicts an exemplary interface for content generation and modification via a chat interface, according to aspects of the present disclosure.

FIG. 8A illustrates a flowchart diagram of an exemplary method for indicating AI-generated content in an AI-integrated environment, according to aspects of the present disclosure.

FIG. 8B depicts an exemplary interface for indicating AI-generated content via a chat interface, according to aspects of the present disclosure.

FIG. 9A illustrates a flowchart diagram of an exemplary method for generating a chat history in an AI-integrated environment, according to aspects of the present disclosure.

FIG. 9B depicts an exemplary interface for generating a chat history via a chat interface, according to aspects of the present disclosure.

FIG. 10A illustrates a flowchart diagram of an exemplary method for providing citations to references in an AI-integrated environment, according to aspects of the present disclosure.

FIG. 10B depicts an exemplary interface for providing citations to references via a chat interface, according to aspects of the present disclosure.

FIG. 11 illustrates a block diagram of an exemplary computer system for implementing one or more aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for AI assistant integration in a user interface (UI).

Many different business computer environments, and in particular those that serve customer or subscriber needs, may include one or more machine learning (ML) models that can be used by customers to carry out various tasks. For example, a customer sales environment may be used by subscribers to track sales team statistics, as well as account information of their customers. Such account information may include information relating to a sales individual or sales team, including volume or dollars sold, number of accounts being handled, and customer business and contact information, and sales targets. Meanwhile, the account information may further include information relating to the different accounts, such as customer business information, primary contacts, pending accounts, account targets etc. In such an environment, machine learning models may be made available to the subscribers in order to assist them with their various business tasks in the form of an integrated AI assistant. In aspects, such tasks may include a wide range of requests, from something as fundamental as making a request for information (e.g., “what is the contact information of the primary point of contact at Company A?”) to something that far more complex (e.g., “For all accounts currently assigned to Salesperson A, generate a spreadsheet showing percentages of sales to those accounts over the various products purchased by those accounts.”).

While AI assistants have been widely available in the business industry, a user unfamiliar with a specific AI assistant or querying said AI assistant may be unaware of tasks the AI assistant can perform or find it challenging to generate a request that returns a desired response. Additionally, when AI assistants are utilized in business workflows, users desire efficient and simple methods to incorporate the AI assistant into their day-to-day tasks. For these reasons, the integrated AI assistant as described in the present disclosure aims provide interoperability between user interfaces and AI assistants, which improves efficiency and provides users with relevant information and options, including the ability to search for records, generate fields, and distinguish between AI-generated and user-edited content. The integrated AI assistant also provides features such as chat history, suggested actions, and citations, which enhance user experience and build trust in AI-generated responses.

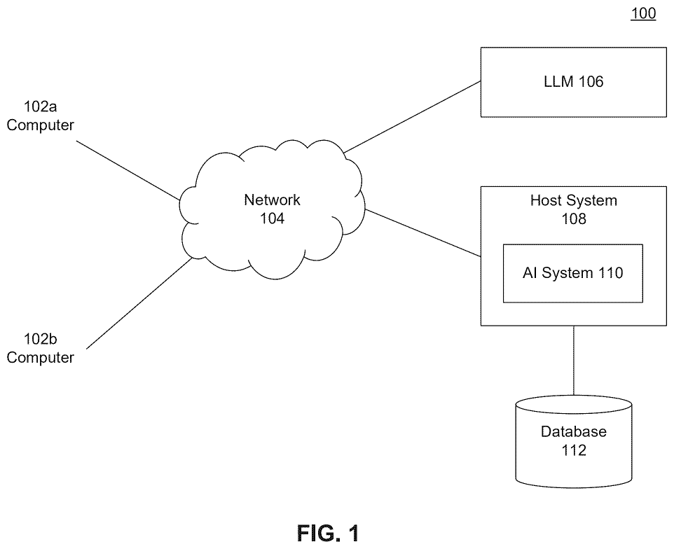

FIG. 1 illustrates an exemplary AI-integrated environment 100, according to embodiments of the present disclosure. As shown in FIG. 1, the environment 100 may include user devices 102a and 102b, which take the form of a mobile device, a personal computer, or other electronics device capable of communicating over a network, such as a smartphone, tablet computer, personal digital assistant, smartwatch, etc. The environment 100 also includes a host system 108. In aspects, the host system 108 may include all interfaces and functionality in support of the user, as well as internal systems. Included within the host system 108 is an AI system 110.

As shown in FIG. 1, the user devices 102a and 102b connect to the host system 108 and the AI system 110 over a network 104. In aspects, network 104 may be any type of computer or telecommunications network capable of communicating data, including but not limited to a local area network, a wide-area network (e.g., the Internet), or any combination thereof. The network may include wired and/or wireless segments. In some aspects, network 104 may be a secure network. In some aspects, one or more of the user devices 102a and 102b may reside within network 104.

LLM 106 may be a machine learning model used to perform various tasks. LLM 106 may be configured using any machine learning architecture. In some aspects, LLM 106 may be built using a transformer architecture. LLM 106 may be trained to perform natural language processing tasks such as text summarization, language translation, and speech recognition. LLM 106 may be interacted with via a chatbot service of AI system 110. For example, LLM 106 may receive natural language query and generate a response. In some aspects, the response may be natural language, a structured payload, or a combination thereof. Including a structured payload may be beneficial to increase processing speeds on the client device. In some aspects, interactions with LLM 106 may be via a command line interface (e.g., headless). LLM 106 may be deployed across various locations at network 104. For example, LLM 106 may be a standalone instance deployed on network 104.

LLM 106 may be trained to receive a prompt and generate a response. The prompt may be multi-modal. For example, the prompt may include text, video, audio, image, or any combination thereof. LLM 106 may be configured to predict a response based on the prompt. LLM 106 may generate the entire response, or part of the response. For example, LLM 106 may be enabled to retrieve data, and include the retrieved data within a response. In some embodiments, the data may be formatted within a natural language response. In some embodiments, the data may be structured data. For example, the data may be in a CSV, JSON, or XML structure. In some embodiments, LLM 106 may alter the format of the data. For example, LLM 106 may be trained to retrieve a value from a JSON structure and insert it within the response. In some embodiments, LLM 106 may be trained to send the data in its stored format. For example, LLM 106 may send the JSON structure within the response. This may be beneficial for the receiving device (e.g., user device 102) to render the data in a chatbot interface and UI.

LLM 106 may be configured to query public and private sources to formulate a response. For example, LLM 106 may access publicly available information (e.g., the internet) to include within a response. Additionally, LLM 106 may access private information. As will be discussed in more detail, host system 108 may function as a back-end system for an application or service on network 104. For example, host system 108 may be a customer relationship management system, and therefore store data regarding customer accounts. Here, LLM 106 may include the host system's data within its response. For example, LLM 106 may query database 112 or other storage devices at host system 108, and include the retrieved information within its response.

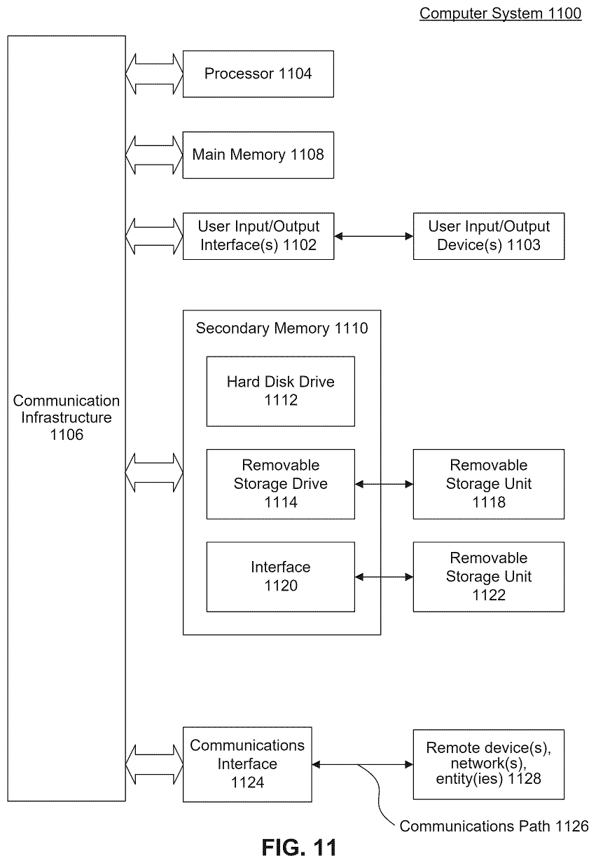

Host system 108 may be configured to access and manage data on network 104. Host system 108 may be implemented using one or more servers and/or databases. In some embodiments, host system 108 may be implemented using a computing device such as a desktop workstation, laptop or notebook computer, netbook, tablet, smart phone, and/or other computing device. In some embodiments, host system 108 may be implemented as an application in an enterprise computing system and/or a cloud-computing system. In some embodiments, host system 108 may be a computer system such as computer system 1100 described with reference to FIG. 11. Host system 108 may include AI system 110 and database 112.

Database 112 may be implemented using a memory device and store data relating to host system 108. For example, host system 108 may be a human resources application, and database 112 may store all the data used by host system 108 such as employee records. As another example, host system 108 may be a financial institution, and database 112 may include financial and accounting records used by host system 108. Database 112 may be further configured to store account information associated with users of host system 108. For example, a user may have to create an account and perform authentication in order to access host system 108.

AI system 110 may be configured to interface with LLM 106. AI system 110 may establish a connection to LLM 106. In some embodiments, LLM 106 may exist as a separate entity on network 104. In some embodiments, LLM 106 may exist locally on user device 102. In some embodiments, LLM 106 may exist at host system 108.

As discussed above, LLM 106 may be a machine learning model natural language processing tasks. LLM 106 may allow for natural language interaction between user device 102 and host system 108. As discussed above, LLM 106 may be deployed at a location on network 110. Here, LLM 106 may be deployed as part of host system 108. Here, AI system 110 may be configured to communicate with LLM 106. For example, AI system 110 may be configured to access and interact with a database at host system 108 (e.g., database 112). AI system 110 and LLM 106 may be leveraged to perform the interactions. For example, as opposed to an SQL query, AI system 110 may display a chatbot interface within user device 102, and be connected to host system 108. The chatbot interface at AI system 110 may receive natural language queries or input (e.g., English text). The natural language query may be sent to host system 108, and interpreted by LLM 106. LLM 106 may use: (1) the natural language query; and (2) a contextual data (e.g., database 112) identifier to create a context for the query.

LLM 106 may convert the query into an API or function call to interact with host system 108 (e.g., an SQL query). The SQL query may be used to access or otherwise interact with database 112. For example the record may be retrieved. In some embodiments, the record may be compressed and/or encrypted after retrieval.

In response, LLM 106 may generate a response. LLM 106 may generate a natural language response. For example, a natural language response may include a summary of the record. In some embodiments, LLM 106 may include parts of the data within the response. For example, LLM 106 may insert fields from the record, or the entire record within the response.

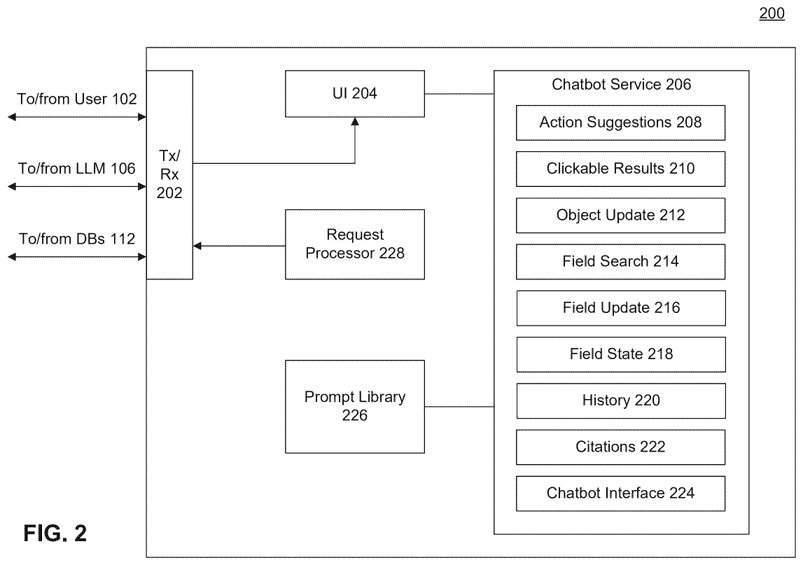

The response (e.g., summary, parts of the record, copy of entire record, etc.) may be returned to user device 102 via network 104. The summary and the record data itself, or a link to the record may be presented within AI system 110. Once received, AI system 110 may query a UI service to determine how AI system 110 should display the information within a chatbot interface. AI system 110 is further described with regards to FIG. 2.

FIG. 2 illustrates an exemplary AI system 200 in an AI-integrated environment, according to aspects of the present disclosure. As shown in FIG. 2, the AI system 200 includes a transceiver 202, a UI 204, a chatbot service 206, a prompt library 226, and a request processor 228. In aspects, the transceiver 202 is capable of communicating with local devices as well as over the network 104 using one or more digital communication protocols. In aspects, the transceiver 202 may be responsible for communicating with the user device 102, LLM 106, as well as the databases 112.

UI 204 may be a service configured to store and manage UI components corresponding to data associated with host system 108. UI 204 may be implemented using one or more servers and/or databases. In some embodiments, UI 204 may be implemented using a computing device such as a desktop workstation, laptop or notebook computer, netbook, tablet, smart phone, and/or other computing device. In some embodiments, UI 204 may be implemented as an application in an enterprise computing system and/or a cloud-computing system. In some embodiments, UI 204 may be a computer system such as computer system 1100 described with reference to FIG. 11. UI 204 may communicate with user device 102 via network 104.

UI 204 may include a store of internal mappings that determine UI components to render at user device 102 in response to data sent from host system 108. As stated above, user device 102 may interact with host system 108 to manage, request, and/or view data. In aspects, UI 204 may be a graphical user interface (GUI), a command line interface (CLI), menu-driven UI, touch UI, or form-based UI. Data at host system 108 may have various types. In order to efficiently view and interact with the data, UI 204 may store components mapped to data types. UI 204 may indicate to user device 102 which component to render, based on the type of data that user device 102 received from host system 108. Data types may include primitive types and composite types.

Primitive types may include strings, integers, and Booleans. Primitive types may be further used to create composite data types. Composite data types may include one or more primitive data types grouped together. For example, a composite data type “Contact” may include two primitive data types: (1) a string corresponding to a name; and (2) a string corresponding to an address. In some embodiments, composite data types may include nested composite data types. Citing the “Contact” example above, it may include: (1) a string corresponding to a name; and (2) a composite data type “Address.” The composite data type “Address” may include: (1) a string corresponding to a city; and (2) an integer corresponding to a zip code.

Chatbot service 206 may be used to perform tasks and update data at host system 108. For example, a user at user device 102 may launch UI 204. Chatbot service 206 may be configured to integrate with UI 204. The user may submit a query for host system 108, through chatbot service 206. The query may relate to a database record or other item stored at database 112. In some aspects, the response may be displayed at chatbot service 206 within chatbot interface 224. In other aspects, the response may be displayed at UI 204. In some aspects, the user may wish to update the retrieved record. For example, the user may input a request to change the record via chatbot interface 224 at chatbot service 206. Chatbot service 206 may send the request to LLM 106. LLM 106 may receive the request. LLM 106 may generate a response. In some embodiments, the response may be natural language, such as a summary of the updated data. In some embodiments, the response may be structured data including a copy of the updated data. This may be beneficial to rapidly detect the data structure, and quickly display it within chatbot interface 224. Chatbot service 206 may then send the response, including the updated data, to user device 102. The response may be displayed at chatbot interface 224 or UI 204.

When chatbot service 206 provides AI system 200 with a request, the request is received at the request processor 228. The request processor 228 performs any additional processing that may be required for generating the appropriate prompt to LLM 106. For example, a request may include calls to external data, such as one or more files or records stored in database 112. In this example, the request processor 228 may retrieve the relevant information from database 112 before prompt generation. Similarly, certain requests may require “translation” into a more understandable format. This may particularly be true for a natural language request. Such translation may be rules based or involve one or more machine learning models in order to decipher the “meaning” and/or “intent” of the request. Once the relevant processing has been performed, the request and the relevant translation or other data are provided to LLM 106.

As described above, chatbot service 206 may be displayed as a chatbot interface 224 within UI 204. A user may input a query to chatbot interface 224. The query may be a function the user may typically perform manually on UI 204. For example, if a user wishes to view a file associated with data displayed on UI 204, as opposed to manually navigating a file structure, the user may input a request such as, “Summarize File ABC.” Chatbot service 206 may forward this request to LLM 106, which may interpret the query and provide a response (e.g., summary of the file). As will be discussed in more detail below, chatbot service 206 may be further used to perform a plurality of actions.

In some aspects, LLM 106 may perform actions based on interactions with user device 102. For example, chatbot service 206 may track and send LLM 106 user interactions with chatbot interface 224. In another example, chatbot service 206 may track parts of chatbot interface 224 a user is interacting with, such as, where a user has clicked, data a user has highlighted, copied, pasted, saved, and deleted. In some aspects, the interactions with chatbot interface 224 may include interacting with interface elements (e.g., buttons, symbol, text fields, list boxes). Chatbot service 206 may record and send these interactions to LLM 106.

In other aspects, chatbot service 206 may track and send LLM 106 user interactions with UI 204. Chatbot service 206 may track parts of UI 204 a user is interacting with, such as, where a user has clicked, data a user has highlighted, copied, pasted, saved, and deleted. In some aspects, the interactions with UI 204 may include interacting with interface elements (e.g., buttons, symbol, text fields, list boxes). Chatbot service 206 may record and send these interactions to LLM 106.

Chatbot service 206 may render UI components (e.g., boxes, buttons, checkboxes, cards, date/time, inputs, modals, menus, loading bars, toggle switches, cards, dropdowns, charts, graphs, and tables) in chatbot interface 224. Chatbot service 206 may update UI 204 at user device 102 using the UI components. For example, if chatbot service 206 is used to update data at host system 108, when the updated data is returned, chatbot service 206 may display the updated data in UI 204.

In some aspects, a prompt template is coupled to each UI component to prompt LLM 106 when a user interacts with the UI component. The prompt template may be stored in prompt library 226. The chatbot service 206 retrieves context data from host system 108 (i.e. for generating a prompt to an LLM using an external data reference included in the prompt template associated with the actionable field). Based on the user's request, the system generates a hydrated LLM prompt where all the data references are resolved in real time at the time of invocation using the prompt template and context data, which is then provided to the LLM for processing. The LLM returns its output, which the system then processes and forwards to the user.

As described above, chatbot service 206 may include interface elements (e.g., buttons, symbol, text fields, list boxes) that when interacted with, perform various actions. These actions may include, but are not limited to, action suggestions 208, clickable results 210, object update 212, field search 214, field update 216, field state 218, history 220, and citations 222. Each action is described in further detail below.

### Predictive Action Suggestions

Predictive action suggestions provide suggestions of tasks that a user can request a chatbot to perform based on the UI page the user is viewing. These tasks may include responding to a query, providing details regarding records, or updating records within the AI-integrated system. The suggestions may be provided to a user on a chatbot feed (i.e., chatbot interface) as a simple button that the user can select using their device, initiating the chatbot to perform the suggested task. These predictive action suggestions allow for seamless use of the chatbot as they provide suggestions that teach and describe the capabilities of the chatbot to the user and creates a simple and efficient way to query a chatbot.

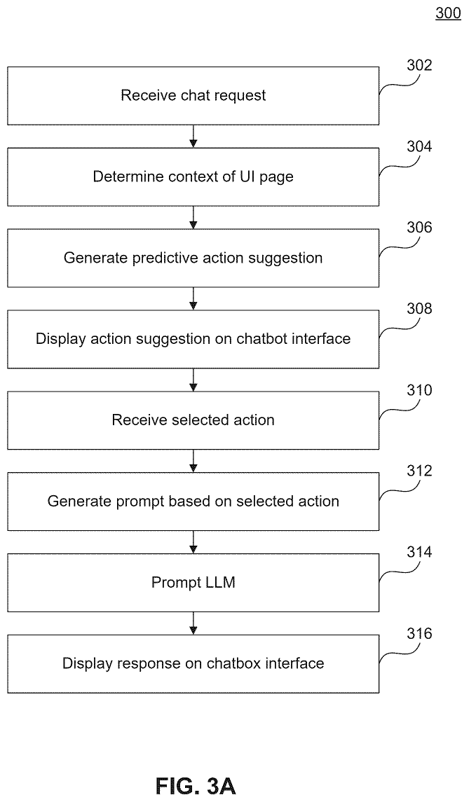

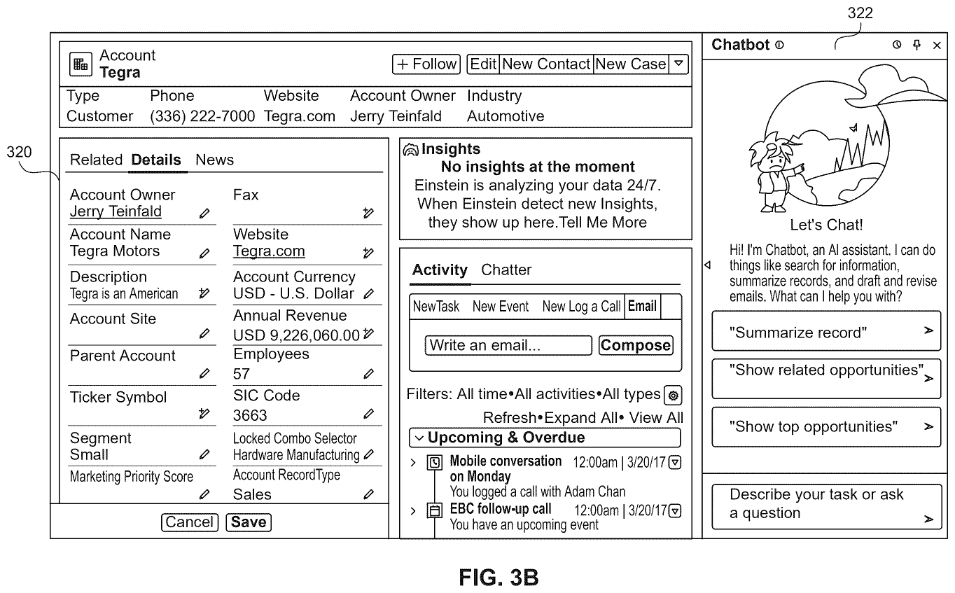

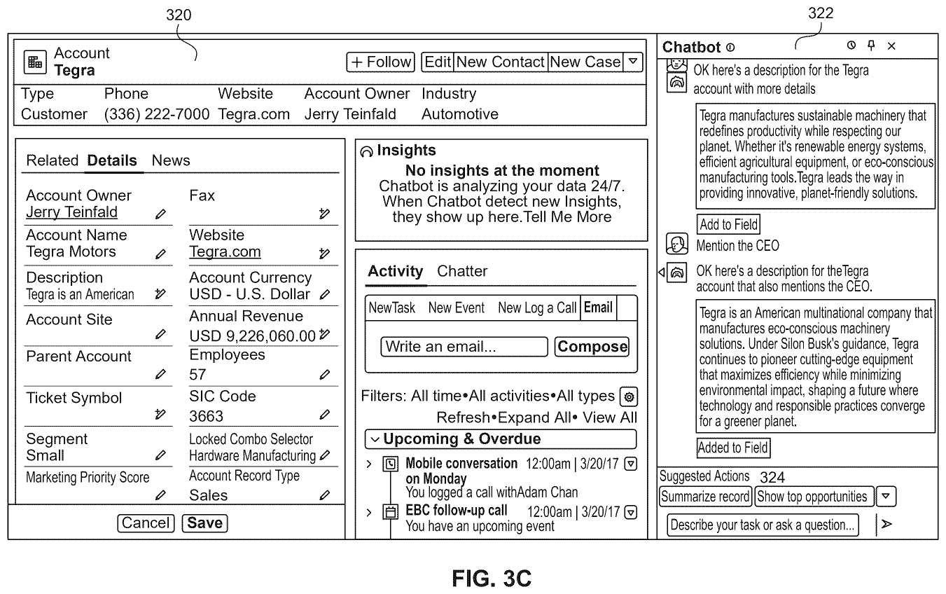

FIG. 3A illustrates a flowchart diagram of an exemplary method 300 for generating action suggestions 208 in an AI-integrated environment, according to aspects of the present disclosure. The methods described herein provide predictive action suggestions to users in order to efficiently perform tasks within the AI-integrated system and provide a guide to users on the actions they can request the system to perform. FIGS. 3B-3C depict exemplary user interface 320 and an integrated chatbot interface 322 that may be provided to a user device.

As shown in FIG. 3A, the method begins at step 302, with the AI system receiving a request from a user device to begin a chat with chatbot service 206. In aspects, the request can be generated by a user interacting with an actionable field in UI 204, interacting with an actionable field in chatbot interface 224, or by simply launching UI 204 on the user device. In some aspects, the request may be automatically generated while a chat is ongoing between chatbot service 206 and the user device.

In step 304, chatbot service 206 may determine the context of data displayed by UI 204 by analyzing the displayed data. In some aspects, chatbot service 206 may analyze data displayed by UI 204 using image processing (i.e., deep learning, neural networks, machine learning algorithms). In some aspects, chatbot service 206 may use natural language processing of the displayed data to determine the context. In other aspects, chatbot service 206 may provide a pre-determined context based on the tasks UI 204 is configured to perform. Attributes that may determine the context of the displayed data may include, but is not limited to, field types within the UI page, tasks to be performed in the UI page, or data within the UI page.

In step 306, chatbot service 206 may generate predictive action suggestions. In aspects, chatbot service 206 may generate action suggestions by selecting a plurality of pre-configured action suggestions from a library of action suggestions based on the determined context. In aspects, the pre-configured action suggestions are customizable. In some aspects, chatbot service 206 selects the plurality of pre-configured action suggestions by prompting an LLM. The prompt may be generated using a pre-configured prompt template configured to generate action suggestions based on the determined context. In some aspects, each of the pre-configured action suggestions may have an associated prompt template configured to prompt an LLM to perform the action suggested by the action suggestion. In aspects, the prompt templates are customizable.

In step 308, chatbot service 206 displays the plurality of action suggestions in chatbot interface 224. As shown in FIG. 3B, the action suggestions may be rendered as actionable items in chatbot interface 322 that, when acted upon (i.e., a click), begins a new chat with chatbot service 206. In aspects, the plurality of action suggestions may be displayed as a list and each action suggestion may be rendered as a clickable action item. In some aspects, the actionable item may be a button. As shown in FIG. 3C, the action suggestions may be rendered as actionable items in a response field 324. Response field 324 may include a list comprising each action suggestion as a clickable action item. In aspects, response field 324 may also include a dropdown menu or other menu types that provide additional action suggestions that chatbot interface 322 may not be able to render due to space limitations of response field 324. Additionally, response field 324 may include a text box that allows the user device to input a query that is not specified by the action suggestions.

In step 310, chatbot service 206 receives a selected action suggestion from the user device.

In step 312, chatbot service 206 generates a prompt based on the selected action suggestion. As described in step 306, the selected action may be associated with a pre-configured prompt template. The prompt template may be configured to prompt an LLM to perform the specific action as suggested by the action suggestion. For example, actions may include providing a summary of data, retrieving data, or modifying data at host system 108 via chatbot service 206. Additionally, the prompt template may be configured to retrieve external data references to provide relevant data to the LLM, specifically any data stored locally or remotely that is expected to be retrieved in order to perform the requested processing. Examples of such data may include locally stored data, such as sales information and records, remotely stored information, such as company representative and contact information, or publicly available data, such as company address, stock price or history, revenue reports, etc. Depending on whether the data is stored locally, remotely, or publicly, this retrieval can include any of a database search query, remote storage retrieval operation, or an Internet or public database search.

In step 314, the LLM is then prompted with the generated prompt. In aspects, this includes issuing a request or command to the LLM to generate an output responsive to the prompt.

In step 316, chatbot service 206 receives a response from the LLM in response to the prompt and displays the response in chatbot interface 224.

It will be understood that the order of the above steps are merely exemplary, and the steps can be rearranged in any appropriate manner. Additionally, more or fewer steps may be included in the exemplary method consistent with the disclosure.

### Clickable Results

When using an AI-integrated assistant, a user may wish to view further details regarding different aspects of the response the chatbot returns. In some instances, a user may wish to view the full record that the chatbot used to generate the response. In some instances, the user may wish to view a complete response if the chatbot provided more information than the chatbot interface could display. For these reasons, responses within a chatbot interface may be rendered with clickable results that allow a user to click on a link within the chatbot interface and view further details on the chatbot interface or the system's UI.

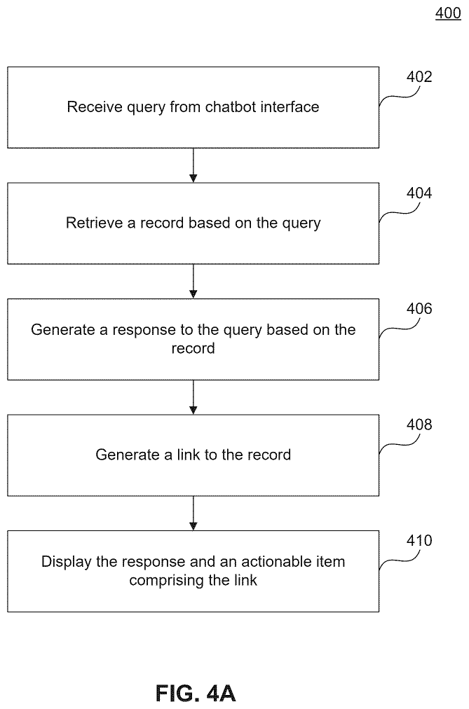

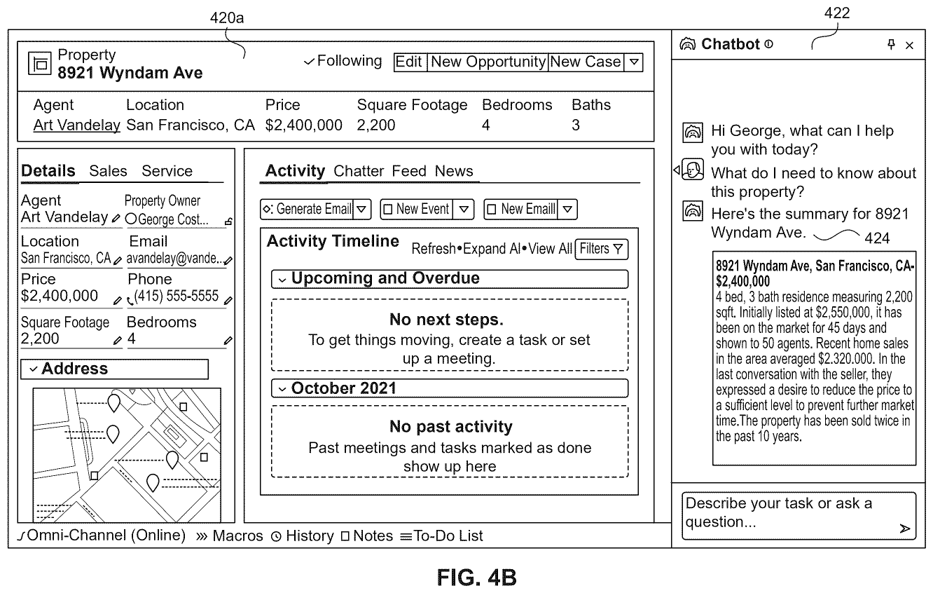

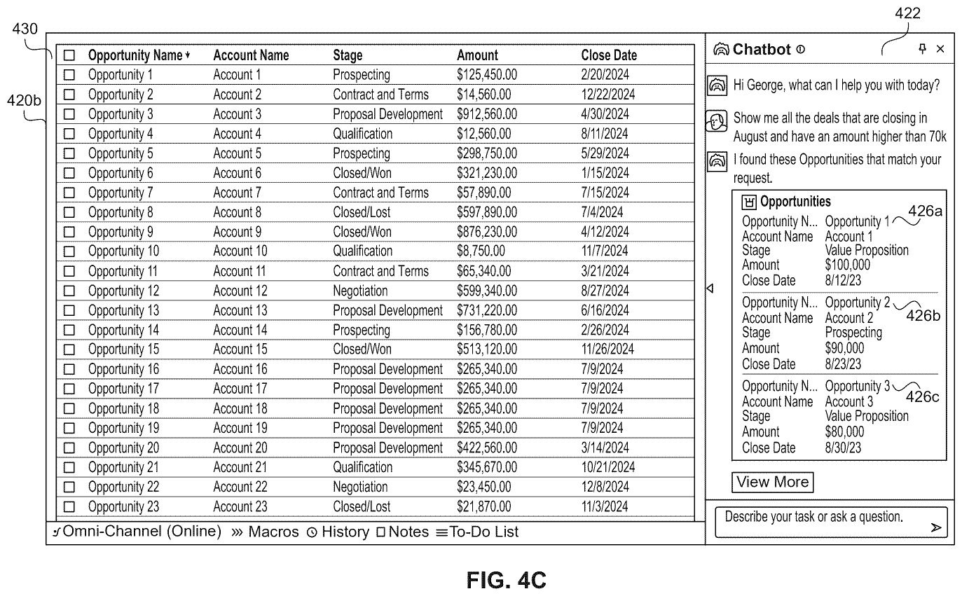

FIG. 4A illustrates a flowchart diagram of an exemplary method 400 for generating clickable results 210 in an AI-integrated environment, according to aspects of the present disclosure. The methods described herein provide UI specific items within a chatbot interface that may be selected by a user and perform certain tasks, including content generation and UI navigation, which increases efficiency and provides improved capabilities of the AI-integrated system. The methods described herein provide FIGS. 4B-4C depict exemplary user interface 420a-b and an integrated chatbot interface 422 that may be provided to a user device.

As shown in FIG. 4A, the method begins at step 402, with the AI system receiving a query input into chatbot interface 224 from a user device. In some aspects, the query may be text input into a text box rendered in chatbot interface 224. In other aspects, the query may be a selection of an action suggestion 208 according to aspects described above. For example, a query might request a summary of data, a list of records, or account information.

In step 404, chatbot service retrieves an external reference to a record or plurality of records based on the query. In aspects, chatbot service 206 processes the query to determine which records to retrieve in order to provide a response to the query. In some aspects, the query may be processed by an LLM. The external reference may correspond to contextual data that is from a local storage, a network storage, or the Internet. In aspects, the contextual data may include CRM data that includes standard and custom objects from the business'local records. In aspects, the contextual data may include cloud data that includes the business'engagement data and unstructured internal data. In aspects, the external reference may be a call to external data sources to semantically retrieve searchable information from publically available data (e.g., articles, PDFs, journals, etc.).

In step 406, chatbot service 206 generates a response to the query based on the record. In aspects, chatbot service 206 generates a prompt configured to provide a response to the query using the external reference to a record. The chatbot service 206 may request an LLM to generate an output responsive to the prompt including the external reference. The external reference may provide object calls that automatically merge data from the records with the prompt at runtime. In some aspects, the external reference may dynamically call data into the prompt based on the user and context of the current UI in use.

In step 408, chatbot service 206 generates a link comprising the external reference to the record. The link may provide access to the record the LLM used to generate the response. In some aspects, chatbot service 206 may generate a plurality of links when a plurality of records are referenced. In some aspects, chatbot service 206 determines which external reference will be linked based on context data including, but not limited to, the prompt, user, or context of the UI in use. The LLM may process the context to determine which external reference to generate a link for. In some aspects, chatbot service 206 determines which item within the response will be rendered with the link based on the context data. The LLM may process the context to determine which external reference to generate a link for and on which item to render the link. In step 410, chatbot service 206 displays the response and an actionable item comprising the link in chatbot interface 224. In some aspects, the link is provided as a hyperlink within the text of the response. In other aspects, the link is provided in a list as an actionable item (e.g., button, list box, etc.). When the hyperlink or actionable item is selected by a user device, the link may navigate the user device to the record. In some aspects, the record may be rendered onto UI 204.

FIG. 4B depicts the functionality of clickable results 210 in response to a query in an integrated AI system. In this example, chatbot service 206 receives a query from a user device requesting a summary of a property. Chatbot service 206 processes the query and retrieves external reference data to records that provide information to summarize the property. Chatbot service 206 generates a link 424 that is rendered to the summary response as a hyperlink in chatbot interface 422. When the user device selects hyperlink 424, UI 420a displays the record that comprises all of the information about the property used to generate the summary.

If the response comprises a plurality of links, chatbot service 206 may determine a subset of the plurality of links to render onto chatbot interface 224 in a list according to dimensional limitations of chatbot interface 224. Chatbot service 206 may then render an actionable item (e.g., dropdown menu, icon, etc.) that, when selected, requests chatbot service 206 to generate a list comprising each link in the plurality of links and render said list onto UI 204.

FIG. 4C depicts the functionality of clickable results 210 to generate an actionable list when the response comprises a plurality of links in an integrated AI system. In this example, chatbot service 206 receives a query from a user device requesting a list of a plurality of business deals that meet a specific threshold. Chatbot service 206 processes the query and retrieves external reference data to business deals that meet the specified threshold. Chatbot service 206 generates a link for each business deal in the plurality of business deals. Because a list of actionable items comprising the plurality of business deals would exceed the dimensional limitations of chatbot interface 422, chatbot service 206 renders a subset of links to the plurality of business deals in chatbot interface 422 as hyperlinks 426a-c in the response and an actionable button 428 that the user device can select to view all of the links. When the user device selects actionable button 428, chatbot service 206 generates a list 430 comprising the link to each business deal in the plurality of business deals and provides list 430 to UI 420b. UI 420b may then display list 430 and provide the links as hyperlinks. When the user device selects a hyperlink in chatbot interface 422 or UI 420b, UI 420b may retrieve the record associated with the hyperlink and display it on UI 420b.

It will be understood that the order of the above steps are merely exemplary, and the steps can be rearranged in any appropriate manner. Additionally, more or fewer steps may be included in the exemplary method consistent with the disclosure.

### Updating Objects

While using an AI-integrated system, a user may wish to update data within a specific record, even if they are not currently viewing the record on the interface. For these reasons, the described AI-integrated system allows a user to request the chatbot from anywhere in the workflow of the system to provide proposed updates and update data stored within the system.

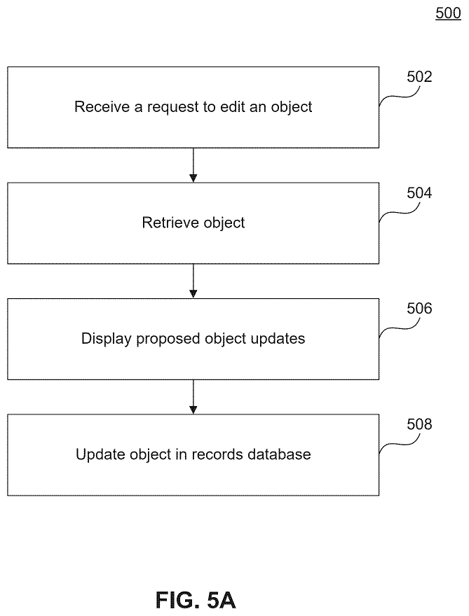

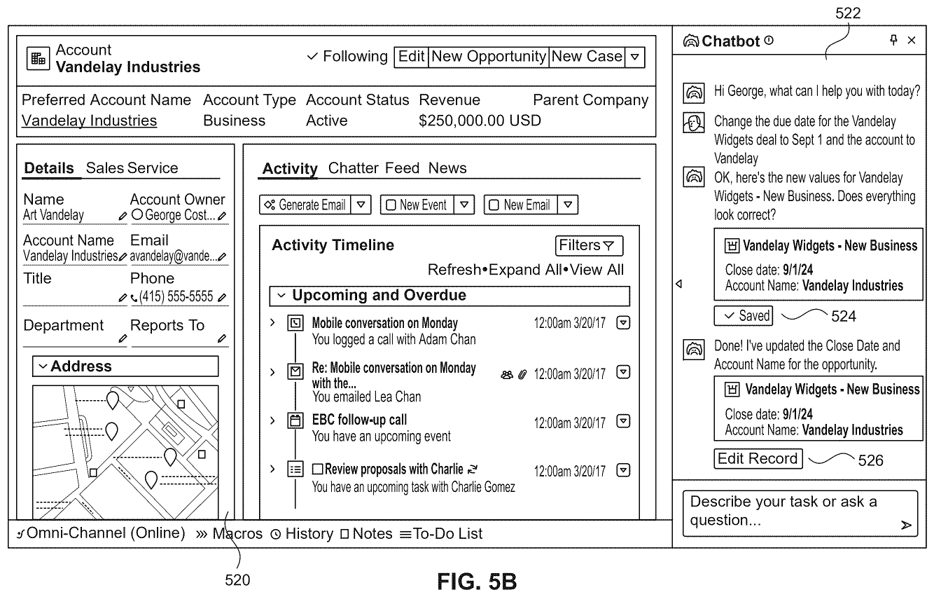

FIG. 5A illustrates a flowchart diagram of an exemplary method 500 for performing object updates 212 in an AI-integrated environment, according to aspects of the present disclosure. The methods described herein allow a user to update data within an AI-integrated system without editing a field directly in a user interface. The AI-integrated system is configured to provide data objects to users within an chatbot interface and edit the data objects within said chatbot interface. FIG. 5B depicts exemplary user interface 520 and an integrated chatbot interface 522 that may be provided to a user device.

As shown in FIG. 5A, the method begins at step 502, with the AI system receiving a request from a user device through chatbot interface 224. In some aspects, the request may be text input into a text box rendered in chatbot interface 224. In aspects, chatbot service 206 prompts an LLM to process the request to determine the updates that should be applied to the requested object.

In step 504, chatbot service 206 retrieves the object to be updated from a records database. Examples of such objects may include locally stored objects, such as sales information and records, remotely stored information, such as company representative and contact information, or publicly available data, such as company address, stock price or history, revenue reports, etc. Depending on whether the object is stored locally, remotely, or publicly, this retrieval can include any of a database search query, remote storage retrieval operation, or an Internet or public database search. In some aspects, chatbot service 206 may render the object onto chatbot interface 224 to receive approval from the user device that the retrieved object is the requested object.

In step 506, chatbot service 206 renders a text box on the chatbot interface 224 that displays proposed updates to the object based on the requested updates. Chatbot service 206 may generate the proposed updates by prompting an LLM to generate a proposed update based on the request and the retrieved object. In some aspects, the chatbot service 206 renders a button that, when selected by the user device, will provide approval of the proposed updates. Chatbot service 206 may also render a button that allows the user device to edit the proposed updates. In some aspects, the user device can continually provide requests to update the object until the chatbot service 206 receives approval from the user device.

In step 508, chatbot service 206 updates the object in the records database based on the requested updates. In some aspects, chatbot service 206 may insert the updated object into the record. In other aspects, chatbot service 206 may overwrite the object with the updated object in the record. In other aspects, chatbot service may insert the updated object into the record and delete the previous object. In some aspects, chatbot interface 224 may display the updated information. In some aspects, UI 204 may retrieve and display the updated object.

FIG. 5B depicts the functionality of object updates 212 in response to a request in an AI integrated system. In this example, chatbot service 206 receives a request from a user device to update a due date and account for a business deal. Chatbot service 206 processes the request by prompting an LLM and retrieving the business deal object. Chatbot service 206 provides a proposed update to the business deal object on chatbot interface 522. When the user device selects button 524 to approve of the update, chatbot service 206 updates the business deal object in the records database. In some aspects Once the update is completed, chatbot interface 522 provides button 526 to the user device that allows the user device to request further updates to the business deal object. UI 520 displays the updated business deal object.

It will be understood that the order of the above steps are merely exemplary, and the steps can be rearranged in any appropriate manner. Additionally, more or fewer steps may be included in the exemplary method consistent with the disclosure.

### Field Searching

Frequently, users utilize interfaces within a host system to retrieve or display data fields stored in the host system. Data fields may be any value within records accessible by the host system. Searching for a data field within a host system like a customer relationship management system can become challenging as the system comprises a plurality of data types, databases, interfaces, networks, etc. Additionally, users may be interested in searching for specific data fields stored within the host system while they are not actively using the interface or record associated with the data field. Field searching using a chatbot service provides users with the capability to search for any data field within a host system without leaving the current interface being used by the user's device.

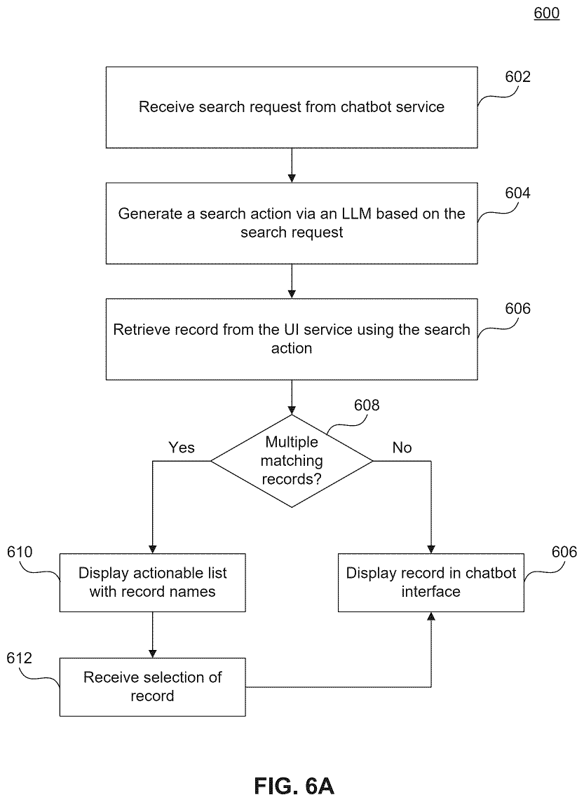

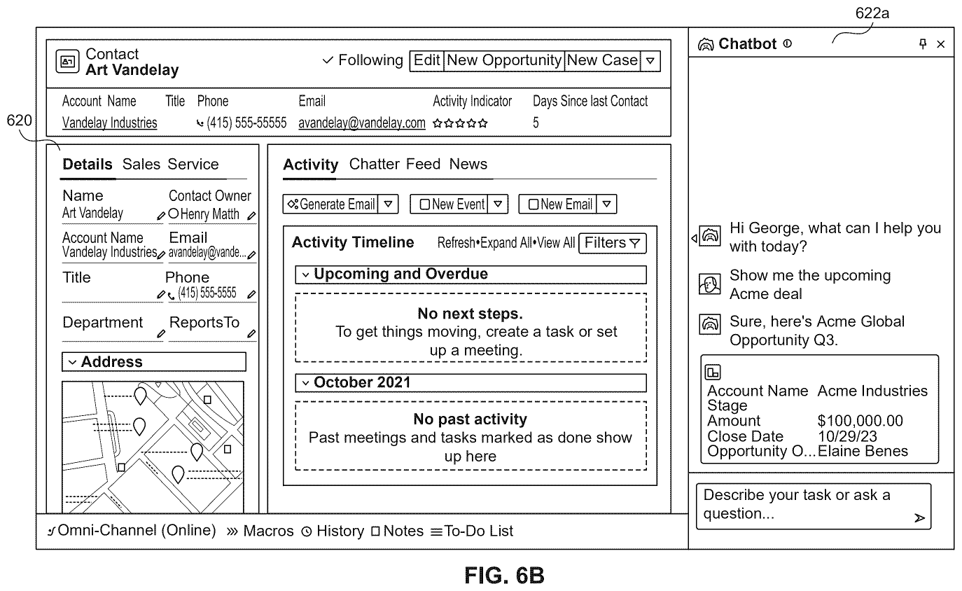

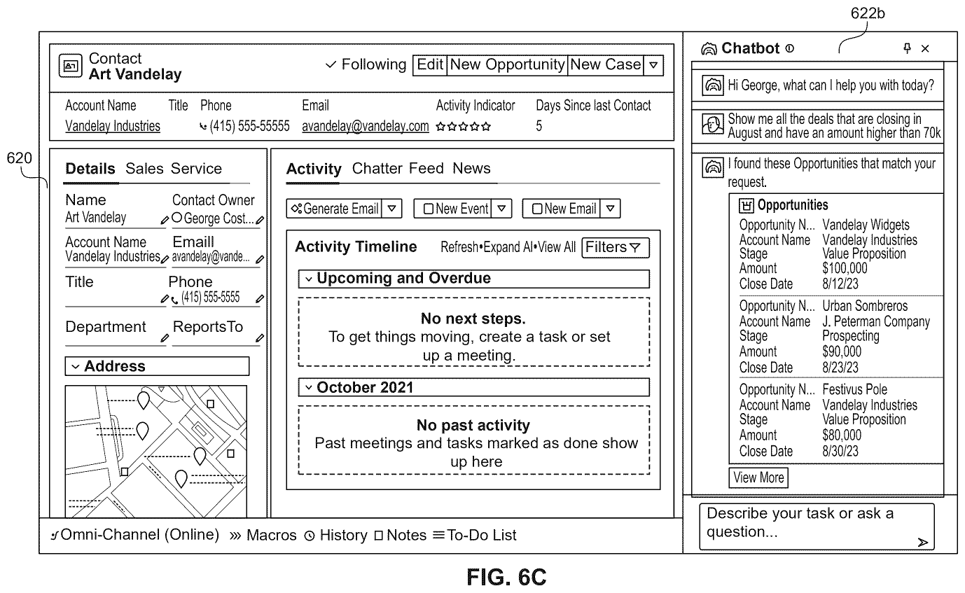

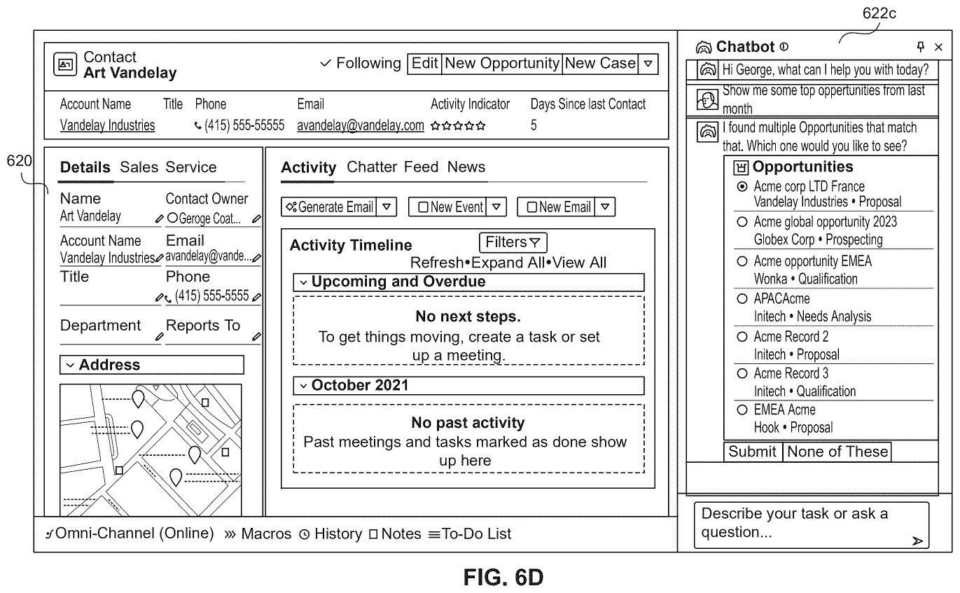

FIG. 6A illustrates a flowchart diagram of an exemplary method 600 for performing field search 214 in an AI-integrated environment, according to aspects of the present disclosure. The methods described herein allow a chatbot service to search for a data field requested by a user within the AI-integrated system without leaving the current interface being used by the user's device. FIGS. 6B-C depict exemplary user interface 620 and an integrated chatbot interface 622a-c that may be provided to a user device.

As shown in FIG. 6A, the method begins at step 602, with the AI system receiving a search request from a user device through chatbot interface 224. In some aspects, the request may be text input into a text box rendered in chatbot interface 224.

In step 604, chatbot service 206 prompts an LLM to generate a search action based on the search request. In aspects, the search action may provide instructions to chatbot service 206 for retrieving a record from a records database (e.g., locally, remote, or publicly available records).

In some aspects, chatbot service 206 may generate the prompt using a prompt template. When generating a prompt, chatbot service 206 may determine that more information is required to generate the prompt. Chatbot service 206 may generate one or more follow up queries, based on the search request, that are displayed in chatbot interface 224. In some aspects, the one or more follow up queries may be generated by an LLM. Chatbot service 206 may request a response to a first follow up query and, when the response is received, request a second follow up query. This may continue until chatbot service 206 determines that the prompt includes sufficient data to prompt the LLM.

In step 606, chatbot service 206 retrieves the record using the search action. Depending on whether the record is stored locally, remotely, or publicly, this retrieval can include any of a database search query, remote storage retrieval operation, or an Internet or public database search.

In step 608, chatbot service 206 determines if multiple records match the search request. If there is only one record (608—NO), chatbot service 206 performs step 614 by displaying the record in chatbot interface 224. In some aspects, the record may be rendered with clickable results as described above. In some aspects, chatbot service 206 may provide a summary of the retrieved record.

FIG. 6B depicts the functionality of field search 214 in response to a search request for a single record in an AI integrated system. In this example, chatbot service 206 receives a search request to display the record associated with a business deal. Chatbot service 206 generates a prompt based on the search request and prompts the LLM with said prompt. The LLM responds with a search action to retrieve the record associated with the business deal. Chatbot service 206 renders a summary of the record in chatbot interface 622a and provides hyperlinks to the record within the summary of the record. The user device may select a hyperlink in order to view the record in UI 620.

Returning to step 608, if there are multiple records matching the search request (608—YES), chatbot service 206 performs step 610 by displaying each record in chatbot interface 224. In some aspects, each record may be rendered with clickable results as described above. The clickable results may be hyperlinks to the records. In other aspects, chatbot service 206 may require further clarification regarding which record is requested in the search request. In response, the matching records may be rendered as a list comprising each record and a selection component (i.e., a button) that allows the user device to select a specific matching record. In some aspects, chatbot service 206 may provide a summary of each record to chatbot interface 224.

As depicted in FIG. 6C, chatbot service 206 may render each matching record in chatbot interface 622b. In some aspects, chatbot service 206 renders a summary of each record in chatbot interface 622b as a list and provides hyperlinks to the record within the summary of the record. The user device may select a hyperlink within chatbot interface 622b in order to view the record in UI 620.

In step 612, when the matching records are rendered as a list comprising a selection component, chatbot service 206 may receive a selection of a record in the displayed matching records.

As depicted in FIG. 6D, chatbot service 206 may determine that the requested opportunity corresponds to multiple records. As a result, chatbot service 206 may request clarification as to which records the user device wishes to access by rendering the records as a list comprising selection components in chatbot interface 622c.

It will be understood that the order of the above steps are merely exemplary, and the steps can be rearranged in any appropriate manner. Additionally, more or fewer steps may be included in the exemplary method consistent with the disclosure.

### Field Updating

While users are filling out a form or entering information into a user interface, a user may request the AI-integrated system to generate text that is to be provided to a specific field within the form. This allows a user device to remain in the form while also retrieving data from anywhere within the host system that is relevant to the context of the field. The chatbot may then fill in the field with text that accurately provides information to the field using the data.

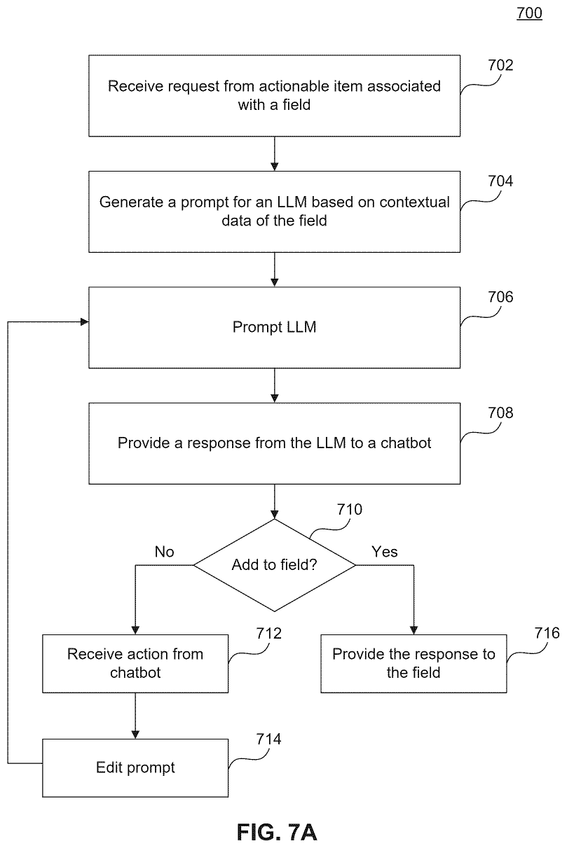

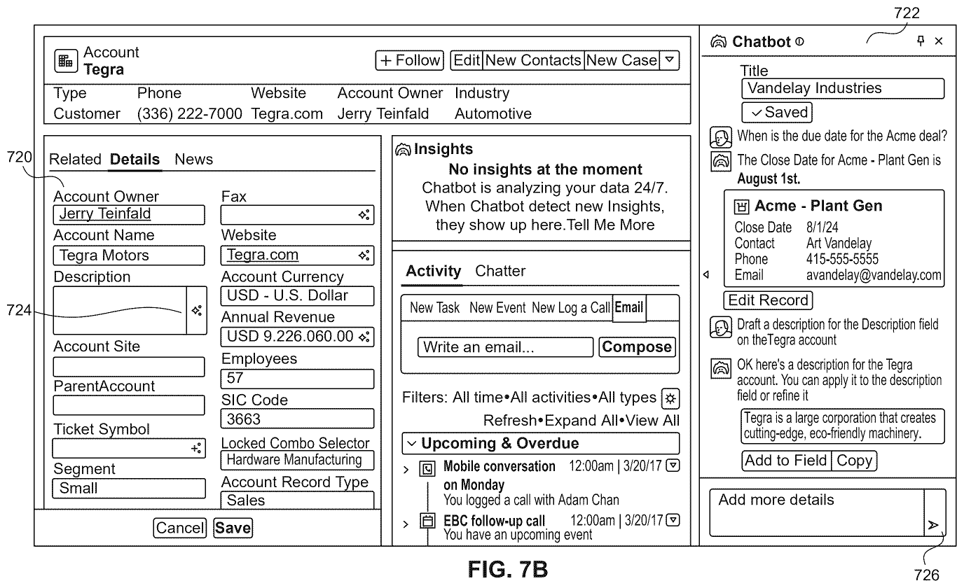

FIG. 7A illustrates a flowchart diagram of an exemplary method 700 for performing field update 216 in an AI-integrated environment, according to aspects of the present disclosure. FIG. 7B depicts exemplary user interface 720 and an integrated chatbot interface 722 that may be provided to a user device.

As shown in FIG. 7A, the method begins at step 702, with the AI system receiving a request from an actionable item within UI 204 or chatbot interface 224 to update or modify a field in UI 204. For example, actionable items include, but are not limited to, text areas, text boxes, list boxes, and icon buttons. In some aspects, the actionable item may be text input into a text box or text area rendered in chatbot interface 224. In aspects, the request is a single click action on an icon button or list box. In other aspects, the request is a query in a text area. In aspects, the request can be in a variety of different forms, such as natural language, Boolean, etc. The actionable item may be rendered in chatbot interface 224 or UI 204. The actionable item may be associated with a field in UI 204 or chatbot interface 224.

As depicted in FIG. 7B, the actionable item may be icon button 724 rendered by UI 720. Icon button 724 is associated with a “Description” field and is therefore configured to provide a description response when icon button 724 is selected. In other aspects, the actionable item may be text box 726 rendered in chatbot interface 722. The user device may input a string that requests a field to be updated.

In step 704, chatbot service 206 generates a prompt for an LLM based on the context of the field. The prompt may be configured such that the LLM responds with a proposed modified field. The context of the field may be, for example, an email, a summary text area, a description text area, or a query text area. In some aspects, chatbot service 206 may use natural language processing of the field to determine the context. In other aspects, the actionable item may be configured with a pre-determined context based on the type of data the field requires or the task of the field. In some aspects, chatbot service 206 may generate the prompt using a prompt template associated with the actionable item.

In step 706, chatbot service 206 prompts an LLM with the generated prompt to provide a modified field based on the request.

In step 708, chatbot service 206 provides the response to chatbot interface 224. Chatbot interface 224 may provide actionable items that are configured to allow the user device to provide further edits to the field (710—NO) or update the field with the response (710—YES).

As depicted in FIG. 7B, chatbot interface 722 may display the proposed modified field and a plurality of actionable items that are configured to request chatbot service 206 to edit the record further or update the field with the proposed modified field.

If chatbot service 206 receives a request to continue modifying the field (710—NO), in step 712, chatbot service 206 receives a secondary request from an actionable item. The secondary request may provide instructions to modify the original request, add data to the modified field, remove data from the modified field, or any other modifications the user device wishes to make.

In step 714, based on the secondary request, chatbot service 206 may edit or modify the generated prompt and return to step 706.

If chatbot service 206 receives a request to update the field with the response (710—YES), in step 716, chatbot service 206 may provide the response to the field. The modified field may be stored or updated in the records database that the field is stored. Additionally, chatbot service 206 may provide the response to the field within UI 204 to be displayed by UI 204.

It will be understood that the order of the above steps are merely exemplary, and the steps can be rearranged in any appropriate manner. Additionally, more or fewer steps may be included in the exemplary method consistent with the disclosure.

### Field States

As the use of generative AI has become increasingly popular to perform business tasks, it has become increasingly important for systems to provide transparency in regards to AI-generated content. This is because users and businesses must ensure that AI generated data is correct and accurate and many users or businesses require that AI-generated content is labelled as such. The described AI-integrated system provides this transparency by determining and displaying relevant information pertaining to the state of a field (i.e., generated by AI or edited by a user).

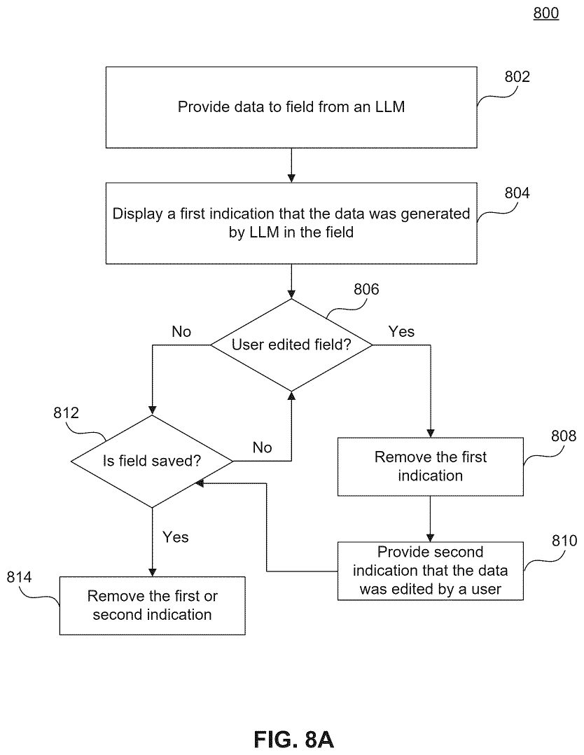

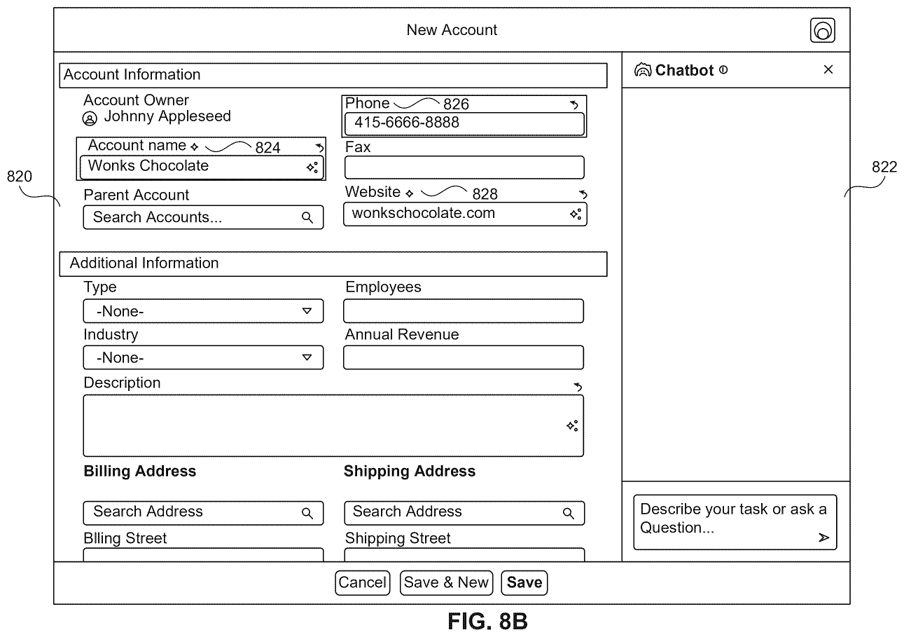

FIG. 8A illustrates a flowchart diagram of an exemplary method 800 for performing field state 218 in an AI-integrated environment, according to aspects of the present disclosure. The methods described herein provide a clear distinction to users on whether content within a UI was generated by AI, which has been increasingly important as users utilize AI in many different aspects of business workflows. FIG. 8B depicts exemplary user interface 820 and an integrated chatbot interface 822 that may be provided to a user device.

As shown in FIG. 8A, the method begins at step 802, with the AI system receiving a response from an LLM through chatbot service 206. In some aspects, the LLM may be providing a response based on a request to the LLM by chatbot service 206 to update a field within UI 204. In some aspects, the request may be a request to perform field update 216. When the response is received by chatbot service 206, chatbot service 206 may provide the response to the field that was requested to be updated to UI 204. In some aspects, chatbot service 206 may display the response in chatbot interface 224 and provide an actionable item that, when selected by the user device, provides the response to the field.

In step 804, UI 204 displays a field state indication that the updated field was generated by an LLM. In some aspects, the field state indication may be an icon. In some aspects the indication may be a highlighted text box within UI 204 of a specific color. In some aspects, the indication may be text that describes that the data in the field was generated by AI. As shown in text box 824 and 828, the highlighted portion indicates that the account name and website were generated by chatbot service 206. Text box 824 and 828 further include an icon that indicates the data was generated by chatbot service 206. In some aspects, UI 204 may provide an icon to the updated field that, when selected by the user device, reverts the updated field to the previous field state.

In step 806, UI 204 determines whether a user made further edits to the updated field. At step 812, if the field was not edited by the user device (806—NO), UI 204 determines if the field has been saved in the database that the field is associated with. If UI 204 determines the field has not been saved (812—NO), UI 204 returns to step 806.

If the field was further edited by a user (806—YES), at step 808, UI 204 removes the field state indication that the updated field was generated by chatbot service 206.

In step 810, UI 204 displays a field state indication that the updated field was edited by the user device. In some aspects, the field state indication may be an icon. In some aspects the indication may be a highlighted text box within UI 204 of a specific color. In some aspects, the indication may be text that describes that the data in the field was edited by the user device. As shown in text box 826, the highlighted portion indicates that the phone number was edited by the user device. In text box 826, UI 204 removes the icon that indicates the data was generated by chatbot service 206. In some aspects, UI 204 may provide an icon to the edited field that, when selected by the user device, reverts the updated field to the previous field state.

In step 812, UI 204 determines if the edited field has been saved in the database that the field is associated with. At step 814, if the updated field or edited field have been saved (812—YES), UI 204 removes the field state indication.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

### Chat History

In previous systems, a conversation within a chatbot feed would not be stored once the conversation closed. This creates a challenge for users because many times users need to refer back to specific information or conversations held with the chatbot. In other instances, a user may have to close the chatbot mid-conversation and needs to return to the conversation after restarting the chatbot. For these reasons, the described AI-integrated system provides a chat history feature that stores chatbot conversations and allows a user to return to previous conversations even after the chatbot has been closed.

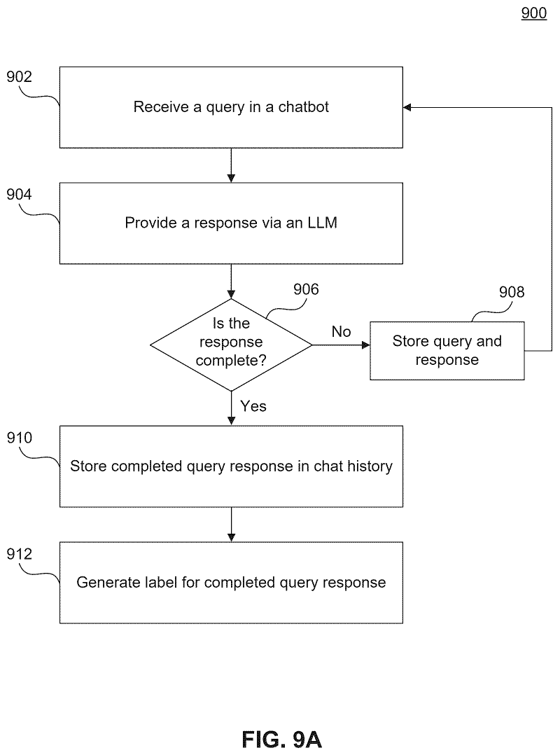

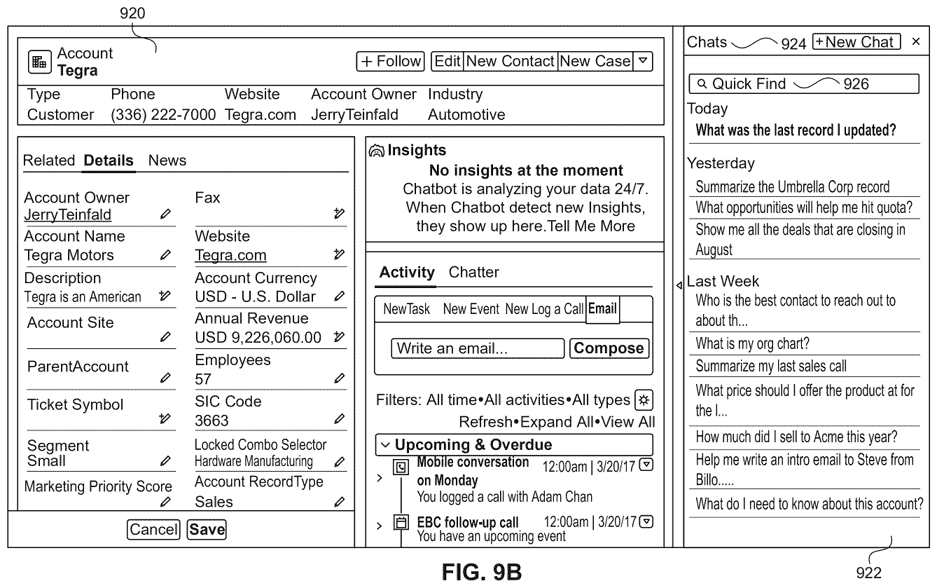

FIG. 9A illustrates a flowchart diagram of an exemplary method 900 for performing chat history 220 in an AI-integrated environment, according to aspects of the present disclosure. The methods described herein allow users to refer back to previous conversations that previous AI-integrated systems would have deleted or not stored after the chatbot conversation was concluded. FIG. 9B depicts exemplary user interface 920 and an integrated chatbot interface 922 that may be provided to a user device.

As shown in FIG. 9A, the method begins at step 902 with the AI system receiving a query input into chatbot interface 224 from a user device. In some aspects, the query may be text input into a text box rendered in chatbot interface 224. In other aspects, the query may be a selection of an action suggestion 208 according to aspects described above. For example, a query might request an object update 212, a field search 214, or a field update 216.

In step 904, chatbot service 206 may provide a response to the query via an LLM. The response may be another query or a response to the query.

In some aspects, chatbot service 206 may generate one or more follow up queries, based on the query, that are displayed in chatbot interface 224. In some aspects, the one or more follow up queries may be generated by the LLM. In some aspects, the user device may provide another query to chatbot service 206 that is related to the previous query.

In step 908, if chatbot service 206 determines that the response to the query is incomplete or the user device inputs another query relating to the previous query (906—NO), chatbot service 206 will store the query and response into a chat history. Chatbot service 206 will then return to step 902.

In step 910, if UI 204 determines that the response to the query is complete or the user device has finished the query (906—YES), chatbot service 206 may store the completed query response in the chat history. In some aspects, chatbot service 206 may determine the response is completed when the user device closes chatbot interface 224. In some aspects, the chat history may be stored locally or remotely (i.e., cloud-based database).

In step 912, chatbot service 206 generates a label for the stored chat history. In some aspects, the label may be the first query stored in the chat history. In other aspects, an LLM may generate a label that summarizes the stored chat history.

As shown in FIG. 9B, chatbot interface 922 may provide a history interface 924 that allows the user device to view a plurality of stored chat histories. In some aspects, history interface 924 provides a text box 926 that allows the user device to search the stored chat histories. History interface 924 may provide the labels of each chat history as actionable items. When a user device selects a label in history interface 924, chatbot service 206 may render the stored chat history on chatbot interface 922. In other aspects, chatbot service 206 may render the stored chat history on history interface 924. In some aspects, the user device may select an actionable item rendered in history interface 922 that, when selected, begins a new chat between the user device and chatbot service 206.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

### Citations

One challenge with implementing AI is that many users mistrust AI-generated content, especially when generative AI has been known to produce hallucinations. For these reasons, the described AI-integrated system provides users with links to the references that it used to generate a response to a user request. This allows viewers to quickly view information that was included in the response and builds user's confidence in the AI-generated content.

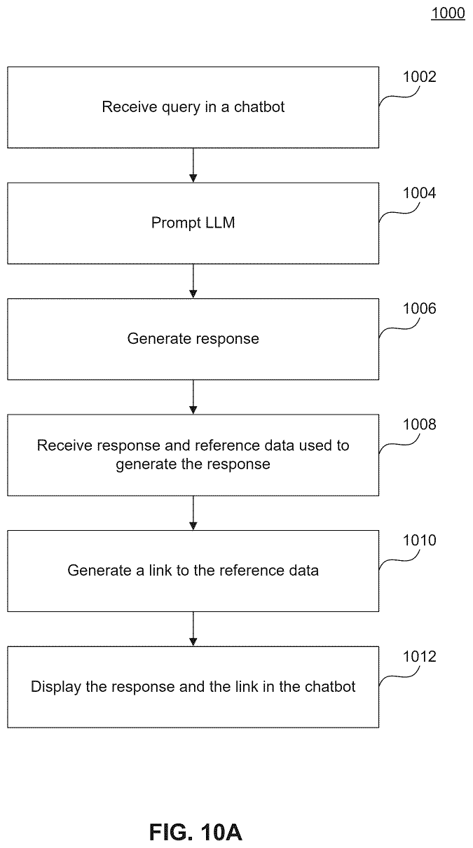

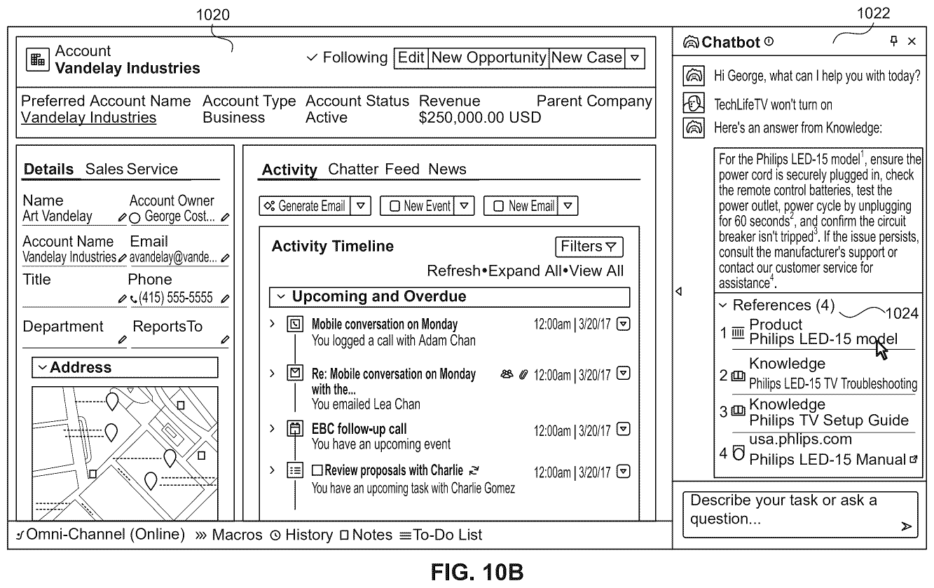

FIG. 10A illustrates a flowchart diagram of an exemplary method 1000 for performing citations 222 in an AI-integrated environment, according to aspects of the present disclosure. Citations 222 provide references to data and records utilized by the AI-integrated environment to generate an AI-generated response. The methods described herein provide a solution to user's lack of trust in AI-generated content by providing transparent responses to queries made by a user. FIG. 10B depicts exemplary user interface 1020 and an integrated chatbot interface 1022 that may be provided to a user device.

As shown in FIG. 10A, the method begins at step 1002 with the AI system receiving a query input into chatbot interface 224 from a user device. In some aspects, the query may be text input into a text box rendered in chatbot interface 224. In other aspects, the query may be a selection of an action suggestion 208 according to aspects described above. For example, a query might request an object update 212, a field search 214, or a field update 216.

In step 1004, chatbot service 206 generates a prompt based on the query and prompts an LLM with said prompt. In some aspects, the prompt may include external data references to contextual data. Additionally, the prompt may include instructions to return external data references to the records that the LLM used to generate a response. The records may be data stored locally or remotely that is expected to be retrieved in order to perform the requested processing. Examples of such data may include locally stored data, such as sales information and records, remotely stored information, such as company representative and contact information, or publicly available data, such as company address, stock price or history, revenue reports, etc. Depending on whether the data is stored locally, remotely, or publicly, this retrieval can include any of a database search query, remote storage retrieval operation, or an Internet or public database search.

In step 1006, chatbot service 206 may receive a response from the LLM. The response may include a response to the query and the external data references to the records used by the LLM to generate the response.

In step 1008, chatbot service 206 generates a link to the records using the external data references. In some aspects, the link may be generated by the methods described above for generating clickable results 210.

In step 1012, chatbot service 206 displays the response and the generated links in the chatbot interface 224. In some aspects, the link is provided as a hyperlink within the text of the response. In other aspects, the link is provided in a list as an actionable item (e.g., button, list box, etc.). When the hyperlink or actionable item is selected by a user device, the link may navigate the user device to the record. In some aspects, the record may be rendered onto UI 204.

As shown in FIG. 10B, chatbot interface 1022 renders a response to a query provided by the user device to chatbot service 206. The response includes a summary of a plurality of records to respond to the query and a list box 1024 comprising actionable items that provide links to the plurality of records.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include customer input/output device(s) 1103, such as monitors, keyboards, pointing devices, etc., which may communicate with communication infrastructure 1106 through customer input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random-access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 514 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system, comprising:
an LLM;
a memory; and
at least one processor coupled to the memory and configured to perform operations comprising:
generating, by a chatbot service coupled to a UI service, an action suggestion based on a context of data displayed by the UI service;
displaying the action suggestion as an actionable object on a chatbot interface provided by the chatbot service; and
prompting, based on selection of the actionable object, the LLM to provide a response to the selected action suggestion with an action prompt configured based on the selected action suggestion and that comprises external reference data.

2. The system of claim 1, wherein the context is determined by the LLM.

3. The system of claim 1, wherein the UI service is at least one of a graphical user interface (GUI), a command line interface (CLI), menu-driven UI, touch UI, or form-based UI.

4. The system of claim 1, wherein the generating occurs in response to a request from the UI service.

5. The system of claim 1, wherein the generating occurs in response to a request from the chatbot service.

6. The system of claim 1, wherein the selected action suggestion and the response are stored in a chat history provided by the chatbot service.

7. The system of claim 1, wherein the action suggestion is generated by the LLM.

8. The system of claim 1, wherein the action suggestion is generated by selecting, based on the context data, an action suggestion from a plurality of pre-configured actions.

9. The system of claim 8, wherein the plurality of pre-configured actions are customizable.

10. The system of claim 1, wherein the action suggestion suggests modifying data within the UI service.

11. The system of claim 1, wherein the action suggestion suggests searching for data within the UI service.

12. The system of claim 1, wherein the action suggestion suggests generating new data for the UI service.

13. A method, comprising:
generating, by a chatbot service coupled to a UI service, an action suggestion based on a context of data displayed by the UI service;
displaying the action suggestion as an actionable object on a chatbot interface provided by the chatbot service; and
prompting, based on selection of the actionable object, the LLM to provide a response to the selected action suggestion with an action prompt configured based on the selected action suggestion and that comprises external reference data.

14. The method of claim 13, wherein the context data is determined by an LLM.

15. The method of claim 13, wherein the UI service is at least one of a graphical user interface (GUI), a command line interface (CLI), menu-driven UI, touch UI, or form-based UI.

16. The method of claim 13, wherein the generating occurs in response to a request from the UI service.

17. The method of claim 13, wherein the generating occurs in response to a request from a chatbot service coupled to the UI service.

18. The method of claim 13, wherein the action suggestion is generated by the LLM.

19. The method of claim 13, wherein the action suggestion is generated by selecting, based on the context data, an action suggestion from a plurality of pre-configured actions.

20. A non-transitory computer-readable device having instructions stored thereon that, when executed by at least one computing device, cause the at least one computing device to perform operations comprising:
generating, by a chatbot service coupled to a UI service, an action suggestion based on a context of data displayed by the UI service;
displaying the action suggestion as an actionable object on a chatbot interface provided by the chatbot service; and
prompting, based on selection of the actionable object, the LLM to provide a response to the selected action suggestion with an action prompt configured based on the selected action suggestion and that comprises external reference data.
